(19) United States
(12) Patent Application Publication
(10) Pub. No.: US 2014/0134485 A1
(43) Pub. Date: May 15, 2014

(54) NEGATIVE-ELECTRODE ACTIVE MATERIAL FOR SECONDARY BATTERY, AND NEGATIVE ELECTRODE AS WELL AS SECONDARY BATTERY USING THE SAME

(71) Applicants: National Institute of Advanced Industrial Science and Technology, Tokyo-to (JP); Kabushiki Kaisha Toyota Jidoshokki, Kariya-shi (JP)

(72) Inventors: Takuhiro MIYUKI, Ikeda-shi (JP); Toshikatsu KOJIMA, Ikeda-shi (JP); Yuta IKEUCHI, Ikeda-shi (JP); Masanori MORISHITA, Ikeda-shi (JP); Tetsuo SAKAI, Ikeda-shi (JP); Kazuhito KAWASUMI, Kariya-shi (JP); Masataka NAKANISHI, Kariya-shi (JP); Junichi NIWA, Kariya-shi (JP)

(73) Assignees: National Institute of Advanced Industrial Science and Technology, Tyoko-to (JP); Kabushiki Kaisha Toyota Jidoshokki, Kariya-shi (JP)

(21) Appl. No.: 14/075,496

(22) Filed: Nov. 8, 2013

(30) Foreign Application Priority Data
Nov. 12, 2012 (JP) 2012-248629

(51) Int. Cl. H01M 4/60

(52) U.S. Cl. CPC H01M 4/604
USPC 429/211; 429/213; 525/329.1

(57) ABSTRACT

A negative-electrode active material for secondary battery includes a sulfur-modified polyacrylonitrile. The sulfur-modified polyacrylonitrile includes a polyacrylonitrile, and sulfur being introduced into the polyacrylonitrile.

### INCORPORATION BY REFERENCE

The present invention is based on Japanese Patent Application No. 2012-248629, filed on Nov. 12, 2012, the entire contents of which are incorporated herein by reference.

### BACKGROUND OF THE INVENTION

1. Field of the Invention

The present invention relates to a negative-electrode active material for secondary battery, and a negative electrode as well as secondary battery that use the negative-electrode active material.

2. Description of the Related Art

A lithium-ion secondary battery exhibits high charged and discharged capacities, and is a secondary battery that can be made capable of outputting higher powers. Lithium-ion secondary batteries have been used mainly as a power source for portable electronic appliances at present. Moreover, they are expected to be used as a power source for electric vehicles that have been anticipated to become widespread from now on.

As Japanese Unexamined Patent Publication (KOKAI) Gazette No. 2000-188095 and Re-published Japanese PCT Application Gazette No. 03/034518 disclose, many lithium-ion secondary batteries are constituted of graphite used as the negative-electrode active material, and a lithium-manganese-based composite oxide used as the positive-electrode active material.

A secondary battery, in which a lithium-manganese-based composite oxide is used for the positive electrode and graphite is used for the negative electrode, exhibits large capacities relatively, but produces low discharge voltages. Moreover, such a secondary battery is associated with a fear of short-circuiting at the time of over-discharging, because the precipitation of lithium causes the dendrite of lithium to occur.

Moreover, Japanese Unexamined Patent Publication (KOKAI) Gazette No. 2007-273154 proposes using lithium titanate, instead of graphite, as a negative-electrode active material. If such is the case, the precipitation of lithium does not occur and accordingly any fear of short-circuiting does not arise at the time of over-charging, because the resulting negative-electrode voltage becomes higher. On the contrary, the resultant battery voltage has become lower, and the capacities have also become lower.

### SUMMARY OF THE INVENTION

The present invention has been developed in view of the above-described circumstances. It is therefore an object of the present invention to provide a novel negative-electrode active material for secondary battery, noble negative-electrode active material which contributes to better battery characteristics. It is also another object of the present invention to provide a negative electrode, and a secondary battery that use the novel negative-electrode active material.

Inventors of the present invention had been earnestly searching for negative-electrode active materials that enhance the resulting batteries in terms of the capacities and voltages. As a result, they arrived at thinking of using a sulfur-modified polyacrylonitrile (being hereinafter referred to as “SPAN”), which has been heretofore used as a positive-electrode active material conventionally, as a negative-electrode active material.

The present inventors have been researching and developing sulfur in order to practically apply it to a positive-electrode active material for lithium secondary battery, because it is an inexpensive material and is expected to exhibit high capacities. Moreover, they proposed to use a “SPAN” as a positive-electrode active material in International Publication Gazette No. 2010/044437, for instance. The “SPAN” can be generated by mixing a raw-material powder, which comprises a sulfur powder and a polyacrylonitrile powder, and then heating the raw-material powder in a nonoxidizing atmosphere. Introducing sulfur into polyacrylonitrile upgrades the cyclability of the resulting positive-electrode active materials remarkably, because the introduction can inhibit sulfur from eluting out into electrolytic solutions.

The present invention has been completed based on the idea, namely, using a “SPAN” as a negative-electrode active material.

A negative-electrode active material for secondary battery according to the present invention comprises:

a sulfur-modified polyacrylonitrile including a polyacrylonitrile, and sulfur being introduced into the polyacrylonitrile.

A negative electrode for secondary battery according to the present invention comprises the present negative-electrode active material.

A secondary battery according to the present invention comprises the present negative electrode, a positive electrode, and an electrolyte.

The negative electrode active material for secondary battery according to the present invention comprises a sulfur-modified polyacrylonitrile (or “SPAN”), namely, a composite of sulfur and polyacrylonitrile. Sulfur makes the resulting battery capacities greater theoretically. Moreover, sulfur is an inexpensive material because the amount as a resource is abundant. In addition, the “SPAN” is a compound that is less likely to elute out into electrolytic solutions. Depending on how the “SPAN” is combined with positive-electrode active materials, using the “SPAN” as a negative-electrode active material enables the resultant batteries to produce higher discharge voltages. Thus, the negative-electrode active material for secondary battery according to the present invention, and a negative electrode using the same enable the resulting secondary batteries to exhibit better battery characteristics.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure.

FIG. 1 is a diagram for illustrating the result of an X-ray diffraction analysis for a “SPAN.”

FIG. 2 is a diagram for illustrating a Raman spectrum that the “SPAN” exhibited.

FIG. 3 is a diagram for illustrating a production apparatus for “SPAN.”

FIG. 4 is a diagram for illustrating charging and discharging curves that a secondary battery according to Example No. 1 of the present invention when an electric current was flowed at a constant rate of 0.2 C.

FIG. 5 is a graph for illustrating the results of a cyclic test for the present secondary battery according to Example No. 1 when an electric current was flowed at a constant rate of 0.2 C.

FIG. 6 is a diagram for illustrating charging and discharging curves that the present battery according to Example No. 1 exhibited when an electric current was flowed while changing the rate from 0.2 C to 2 C.

FIG. 7 is a diagram for illustrating the results of a cyclic charging/discharging test for the present secondary battery according to Example No. 1 when an electric current value was flowed while changing the rate from 0.2 C to 3 C.

FIG. 8 is a diagram for illustrating charging and discharging curves that a secondary battery according to Example No. 2 of the present invention exhibited.

FIG. 9 is a diagram for illustrating charging and discharging curves that a secondary battery according to Example No. 3 of the present invention exhibited.

FIG. 10 is a diagram for illustrating charging and discharging curves that a secondary battery according to Example No. 4 of the present invention exhibited.

FIG. 11 is a diagram for illustrating charging and discharging curves that a secondary battery according to Comparative Example exhibited when an electric current was flowed at a constant rate of 0.1 C.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

Descriptions will be made hereinafter on a negative-electrode active material for secondary battery according to some of preferred embodiments of the present invention, and on a negative electrode as well as a secondary battery using the same.

### Negative-Electrode Active Material for Secondary Battery

A negative-electrode active material for secondary battery according to the present invention comprises a sulfur-modified polyacrylonitrile (being hereinafter referred to as “SPAN”). The “SPAN” includes a polyacrylonitrile, and sulfur being introduced into the polyacrylonitrile.

A “SPAN” exhibits such a high capacity of 600 mAh/g as the actual capacity. Meanwhile, graphite, which has been used mainly in conventional negative-electrode active materials, exhibits a theoretical capacity of 372 mAh/g; however, the theoretical capacity can also approximate the actual capacity. Moreover, non-graphitizable carbon (or hard carbon) also exhibits an actual capacity of from 250 to 400 mAh/g that is smaller like that of graphite. In addition, lithium titanate (e.g., Li₄Ti₅O₁₂), which has been believed to be a negative-electrode active material with higher safety, exhibits a theoretical capacity of 173 mAh/g, but the actual capacity is less than the theoretical value. Thus, the “SPAN” exhibits much higher capacities than do the conventional materials for negative-electrode active material. Hence, the “SPAN” can materialize enabling secondary batteries, such as lithium-ion secondary batteries, to exhibit higher capacities.

As International Publication Gazette No. 2010/044437 discloses, a “SPAN” has been heretofore used as a positive-electrode active material conventionally. A secondary battery, which used a “SPAN” as the positive-electrode active material and which used SiOₓ (where 0.5≦“x”≦1.5) as the negative-electrode active material, exhibited an average discharge voltage of 1.41 V. Since the SiOₓ negative electrode shows a potential region approximating that of lithium battery, it is difficult to raise the battery voltage more than 1.41 V.

On the contrary, the negative-electrode active material according to the present invention comprises a “SPAN.” According to studies by the present inventors, a secondary battery, which used a “SPAN” as the negative-electrode active material and which used, for example, LiNi_{0.5}Mn_{1.5}O₄ as the positive-electrode active material, exhibited an average discharge voltage of about 2.7 V. Thus, using “SPAN” on the negative-electrode side can enhance the battery voltage more than using it on the positive-electrode side.

Graphite, which has been heretofore used as a negative-electrode active material conventionally, exhibits a charged potential for sorbing lithium ions that approximates the oxidation-reduction potential of lithium. Accordingly, lithium ions precipitate electrolytically, so that the dendrite of lithium has occurred at the time of overcharge. Consequently, such a fear might possibly arise that the dendrite of lithium has penetrated through a separator to short-circuit between a positive electrode and a negative electrode. Moreover, since non-graphitizable carbon exhibits a charged potential for sorbing lithium ions that approximates the oxidation-reduction potential of lithium at the time of overcharge, too, the fear of the short-circuiting might possibly arise as well.

On the contrary, a “SPAN” exhibits an average potential at the time of sorbing lithium ions that is higher by 1.8 V than that of lithium. As a result, neither the dendrite of lithium occurs, nor the fear of the short-circuiting arises.

In conventional lithium-ion secondary batteries, it has been often the case to usually employ an aluminum foil for a current collector for the positive electrode, and to employ a copper foil for a current collector for the negative electrode. However, it is not possible to employ aluminum foils for the negative-electrode current collector, because aluminum has alloyed with lithium in such a potential region as about 0.6 V or less with reference to the potential of lithium. Moreover, it is not possible to employ copper foils for the positive-electrode current collector, because copper has oxidized to dissolve when a copper foil is employed for the positive-electrode current collector and is then exposed to such a potential region as about 3.5 V or more with reference to the potential of lithium.

In the present invention, a “SPAN” being used to serve as a negative-electrode active material exhibits an average potential of 1.8 V with reference to the potential of lithium at which it sorbs lithium ions. This property consequently makes it possible to use aluminum foils for negative-electrode current collector. Moreover, not only aluminum foils are less expensive than copper foils, but also the formers are more lightweight than the latters. Hence, the present invention makes it possible not only to keep down the material cost of secondary batteries, but also to materialize making secondary batteries lightweight.

Moreover, in conventional common secondary batteries, an aluminum foil is provided with a positive-electrode layer on both of the front and rear faces, and a copper foil is provided with the negative-electrode layer on both of the front and rear faces. Then, the resulting two foil subassemblies are connected in parallel to each other. On the other hand, bipole-type (or bipolar) batteries comprise a unit cellular construction in which a current collector is provide with a positive-electrode layer on one of the opposite faces and a negative-electrode layer on the other one of the opposite faces. In such a bipolar battery, it is possible to enhance voltages of the resulting battery by stacking the unit cellular constructions one after another and then connecting them in series to each other. It is feasible for bipolar batteries to output higher voltages than common secondary batteries do.

When constituting a bipolar battery of conventional common secondary batteries, it is inevitable to bond a copper foil and an aluminum foil to each other to make a cladded material, or to use a stainless-steel foil that is employable in a wide potential region. Since stainless-steel foils are more expensive than are copper foils and exhibit a higher resistance than do copper foils, they have not been put into practical applications yet. Moreover, since stainless steels have larger specific gravities than aluminum does, they are not suitable for making secondary batteries lightweight.

As described above, the present invention makes it possible to use an aluminum foil, which is the same as those to be used for the current collector of positive electrode, for the current collector of negative electrode. Accordingly, the present invention enables battery manufacturers to provide an aluminum foil with a positive-electrode layer on one of the opposite faces and a negative-electrode layer on the other one of the opposite faces. Consequently, the present invention can simplify bipolar batteries or can constitute bipolar batteries free of any cladding, and besides can make the resulting bipolar batteries lightweight.

Moreover, it is feasible for a “SPAN” to sorb (or occlude) and desorb (or release) not only lithium ions but also sodium ions. Moreover, it is possible for a “SPAN” to produce the same extent of electric capacities comparably when lithium ions are the charge carrier, and when sodium ions are the charge carrier. As a result, it is possible to use a “SPAN” as a negative-electrode active material not only for lithium-ion secondary batteries, but also for sodium-ion secondary batteries.

Moreover, as International Publication Gazette No. 2010/044437 indicates, a “SPAN” has been heretofore used as a positive-electrode active material conventionally, and SiOₓ or graphite has been used a negative-electrode active material. Since these active materials do not include any lithium, namely, the charge carrier, it has been indispensable to dope them with lithium. However, since a “SPAN” is used as a negative-electrode active material in the present invention, combining the negative-electrode active material according to the present invention with a positive electrode that comprises a lithium-containing transition-metal oxides results in making it unnecessary to dope the present negative-electrode active material with lithium.

A negative-electrode active material for secondary battery according to the present invention comprises a “SPAN.” The “SPAN” is made by introducing sulfur into a polyacrylonitrile. Hereinafter, descriptions will be made on the “SPAN,” and on a process for producing the same.

The “SPAN” is a compound in which sulfur is introduced into a polyacrylonitrile (hereinafter being referred to as “PAN”). The “PAN,” namely, a material serving as a raw material for the “SPAN,” can preferably have a powdery shape. Moreover, the “PAN” can preferably exhibit a mass average molecular weight of from 1×10⁴ to 3×10⁵ approximately. In addition, the “PAN” can preferably have an average particle diameter of from 0.5 to 50 μm approximately; and can more preferably have an average particle diameter of from 1 to 10 μm approximately; when being observed by an electron microscope. When the mass average molecular weight and average particle diameter of the “PAN” fall within these ranges, it is possible to make a contact area between the “PAN” and sulfur larger, so that it is possible to react the “PAN” with sulfur highly reliably. As a result, it is possible to inhibit sulfur from eluting out into electrolytic solutions more securely.

Using the “SPAN” as a negative-electrode active material for secondary battery results in making it possible to maintain high capacities that sulfur has inherently. Moreover, the resulting negative-electrode active material exhibits a greatly upgraded cyclability, because sulfur is inhibited from eluting out into electrolytic solutions.

Sulfur is heat treated along with the “PAN.” When heating the “PAN,” it is believed that the “PAN” cross-links three-dimensionally to undergo ring-closing while forming condensed rings (e.g., six-membered rings, mainly). Accordingly, it is believed that sulfur exists within the structure of the “PAN” in which ring-closing reactions have proceeded. Consequently, sulfur is less likely to make contact with electrolytic solutions, or, even when sulfur makes contact with electrolytic solutions, the reaction products are put in a state where they are less likely to elute out into the electrolytic solutions because of the following facts: sulfur is present within the “SPAN” in such a stable state as it is bonded to the “PAN”; or, though sulfur exists as the elementary substance within the “SPAN,” sulfur is enclosed within cross-linked structures that occur when the “PAN” undergoes ring-closing by heating. As a consequence of these, it is possible to inhibit sulfur from eluting out into electrolytic solutions, thereby enabling the “SPAN,” or the negative-electrode active material according to the present invention, to exhibit an upgraded cyclability.

Incidentally, it is possible for a lithium-ion secondary battery having an electrode in which an inorganic sulfur elementary substance serves as an active material to produce large capacities initially. However, the lithium-ion secondary battery has been associated with such a problem that the performance has deteriorated sharply when it is charged and discharged repetitively, because Li₂Sₓ, which is soluble in electrolytic solutions, generate during the repetitive charging and discharging operations to have eventually eluted out into the electrolytic solutions.

Hence, it is possible to think of using organic sulfide, in which sulfur is fixated by the —C—S— bonds, as an active material. Even if such is the case, it is inevitable that the cyclability of the resulting active material has deteriorated due to the following reasons; the —C—S— bonds have been cut off so that Li₂Sₓ generates to elute out into electrolytic solutions eventually; and the —C—S— bonds, which have been cut off once, are less likely to recover the original bonding.

Moreover, even when a sulfur-modified active material is used in which sulfur is fixated in the pores of carbonaceous material, the pores remain to serve as the outlet and inlet for sulfur. As a result, sulfur and electrolytic solutions readily contact one another to generate Li₂Sₓ, and the resulting Li₂Sₓ has eluted out into the electrolytic solutions.

On the contrary, lithium-ion secondary batteries, in which a “SPAN” is used as an active material, all exhibit a better cyclability, and can produce high capacities even after being charged and discharged repetitively. This advantageous effect is believed to result from the fact that sulfur is inhibited from separating from the positive electrode or negative electrode, namely, sulfur and electrolytic solutions are inhibited from contacting with each other.

That is, it is believed that sulfur and a “PAN” coexist simultaneously at temperatures at which the “PAN” undergoes ring-closing reactions so that the sulfur is taken in inside the resulting cross-linked structure of the “PAN,” and so that the sulfur is enclosed in pores that do not have any outlet in the resultant “SPAN.” Thus, the sulfur is inhibited from contacting with electrolytic solutions directly. In other words, it is believed that the resulting active material exhibits a better cyclability because Li₂Sₓ is prevented from eluting out. Note that, even if it is possible for a part of the sulfur to contact with electrolytic solutions directly, it is believed that the resultant active material can keep exhibiting stable charged and discharged capacities after such sulfur has eluted out into the electrolytic solutions at the time of the first round of charging and discharging operations.

Sulfur to be used in a “SPAN” can preferably have a powdery shape in the same manner as a “PAN” to be used in the “SPAN.” It is not limited especially at all as to a particle diameter of the sulfur. However, it is preferable that, when being subjected to a classification using sieves, the sulfur can have sizes falling within such a range that they do not go through a sieve with 40-μm sieve opening but go through another sieve with 150-μm sieve opening. It is more preferable that the sulfur can have sizes falling within such a range that they do not go through a sieve with 40-μm sieve opening but go through another sieve with 100-μm sieve opening.

It is not limited especially at all as to a compounding ratio between a “PAN” powder and a sulfur powder to be used in a “SPAN.” However, the compound ratio, namely, “PAN Powder”:“Sulfur Powder”, can preferably fall in a range of from 1:0.5 to 1:10 by mass ratio. It is more preferable that the compounding ratio can fall in a range of from 1:0.5 to 1:7 by mass ratio. It is much more preferable that the compounding ratio can fall in a range of from 1:2 to 1:5 by mass ratio.

A “SPAN” can be produced as described below. First, a mixed raw material, in which a “PAN” powder and a sulfur powder have been mixed with each other, is heated (i.e., a heat-treatment step). The mixed raw material can be prepared by mixing a “PAN” powder and a sulfur powder one another using a common mixing device, such as a mortar and pestle or a ball mill, for instance. As for the mixed raw material, it is also allowable to use a mixture in which sulfur and a “PAN” have been simply mixed one another, or it is even permissible that the mixed raw material can be formed, for example, as a pelletized shape to use. It is also allowable that the mixed raw material can be made of a “PAN” and sulfur alone, or it is even permissible to further compound common materials, such as conductive additives, which are compoundable in negative-electrode active materials.

When the mixed raw material is heated in the heat-treatment step, sulfur being included in the mixed raw material is taken in into the structure of a “PAN.” The heat-treatment step can also be carried out in an sealed system, or can even be carried out in an open system. In order to inhibit sulfur vapors from dissipating, however, it is preferable to carry the heat-treatment step in a sealed system. Moreover, although it does not matter at all in what atmosphere the heat-treatment step is carried out, it is preferable to carry out the heat-treatment step, for instance, in an atmosphere, which does not prevent sulfur from being taken in into a “PAN,” such as atmospheres not containing any hydrogen and nonoxidizing atmospheres. For example, when hydrogen exists in an atmosphere, such a case might possibly arise that sulfur within a reaction system has been lost, because the sulfur within the reaction system reacts with hydrogen to turn into hydrogen sulfide. Moreover, it is believed that, when the heat-treatment step is done in a nonoxidizing atmosphere, sulfur in the vapor form reacts with a “PAN” simultaneously with ring-closing reactions of the “PAN.” As a result, it is believed possible to produce a “SPAN” that has been modified by sulfur. The “nonoxidizing atmosphere” being referred to herein involves the following: depressurized states whose oxide concentration is made lower to such an extent that oxidation reactions do not proceed; inert-gas atmospheres, such as nitrogen and argon; and sulfur-gas atmospheres.

It is not limited especially at all as to a specific method of making a sealed nonoxidizing atmosphere. For example, the mixed raw material can be put into a container in which sealability is kept to such an extent that sulfur vapors do not dissipate, and then the mixed raw material can be heated after turning the inside of the container into a depressurized state or inert-gas atmosphere. In addition to that, the mixed raw material can be heated in such a state that it is vacuum packed with a material, such as an aluminum laminated film, which is less likely to react with sulfur vapors, for instance. If such is case, lest the generated sulfur vapors should break the packaging material, it is preferable to put the packed mixed raw material into a pressure-resistant container, such as an autoclave holding water therein, for instance, and then to heat the packed mixed raw material, thereby pressurizing the packaging material from the outside by generated water vapors. This method can prevent sulfur vapors from swelling the packaging material to break, because the mixed raw material is pressurized from the outside of the packaging material by generated water vapors.

A time for heating the mixed raw material in the heat-treatment step is not limited especially at all, because it can be set up suitably in compliance with heating temperatures. A preferable heating temperature can be such temperatures that enable the taking-in of sulfur into a “PAN” to proceed, and which cannot alter the resulting “SPAN” in quality. For example, it is preferable to set the heating temperature at from 250 or more to 500° C. or less. It is more preferable to set the heating temperature at from 250 or more to 400° C. or less, and it is much more preferable to set it at from 250 or more to 300° C. or less.

In the heat-treatment step, it is preferable to reflux sulfur. If such is the case, the mixed raw material can be heated so that a part of the mixed raw material turns into a gas and the other part turns into a liquid. In other words, a temperature for heating the mixed raw material can be a temperature or more at which sulfur vaporizes. The “vaporization” as being referred to herein designates that sulfur undergoes phase change from the liquid or solid to the gas, and can result from any of the boiling, evaporation and sublimation. For reference, α sulfur (or rhombic sulfur, being the most stable structure at around ordinary temperature) has a melting point of 112.8° C.; β sulfur (or monoclinic sulfur) has a melting point of 119.6° C.; and γ sulfur (or monoclinic sulfur) has a melting point of 106.8° C. Meanwhile, sulfur has a boiling point of 444.7° C. Incidentally, since the vapor pressure of sulfur is high, it is possible to ascertain the occurrence of sulfur vapor even visually when the temperature of the mixed raw material becomes 150° C. or more. Therefore, it is feasible to reflux sulfur when the temperature of the mixed raw material is 150° C. or more. Note that, in a case where sulfur is refluxed in the heat-treatment step, sulfur can be refluxed using a reflux apparatus with known construction.

Even when sulfur is compounded in an excessive amount in the mixed raw material, it is possible to take in sulfur in a sufficient amount into a “PAN” in the heat-treatment step. Consequently, when sulfur is compounded in an amount too much with respect to that of a “PAN,” it is possible to inhibit the above-described adverse effect resulting from sulfur elementary substance by removing sulfur elementary substance from a post-heat-treatment-step processed body. To be concrete, when a compounding ratio between a “PAN” and sulfur is set at from 1:2 to 1:10 by mass ratio in the mixed raw material, it is possible to inhibit the above-described adverse effect resulting from remaining sulfur elementary substance while taking in sulfur in a sufficient amount into the “PAN” by heating a post-heat-treatment-step processed body at from 200 to 250° C. while subjecting it to depressurizing (i.e., a sulfur-elementary-substance removal step). When a post-heat-treatment-step processed body is not subjected to such a sulfur-elementary-substance removal step, the processed body can be used as a “SPAN” as it is. Moreover, when a post-heat-treatment-step processed body is subjected to such a sulfur-elementary-substance removal step, the resulting post-sulfur-elementary-substance-removal-step processed body can be used as a “SPAN.” Although a time for the sulfur-elementary-substance removal step is not limited especially at all, it is preferable to set the time to fall in a range of from 1 to 6 hours approximately.

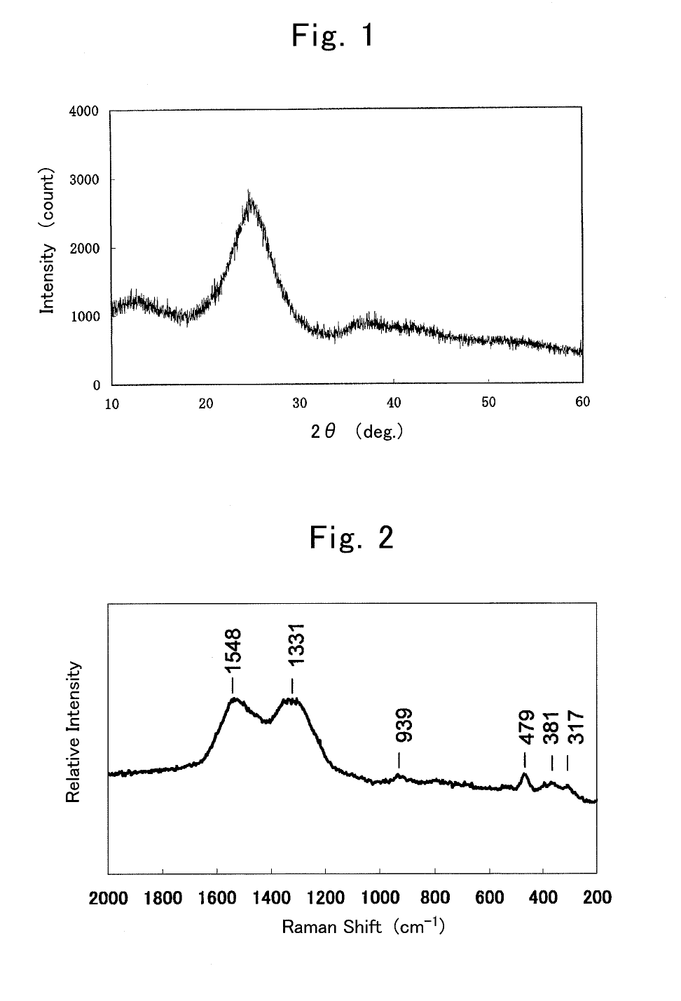

According to the result of an elemental analysis, it was found that a “SPAN” comprises carbon, nitrogen, and sulfur. In certain cases, however, it was found as well that the resulting “SPAN” further comprises oxygen and hydrogen in a small amount, respectively. Moreover, according to the result of an X-ray diffraction analysis with the CuKα ray, it was ascertained that a “SPAN” exhibits a broad peak alone that has a peak position at around 25 degrees in a range where the diffraction angle (2θ) is from 20 to 30 degrees, as shown in FIG. 1. For reference, the X-ray diffraction analysis was an X-ray diffraction measurement that was carried out by a powder X-ray diffractometer (e.g., “M06XCE,” the model number, a product of MAC Science Corporation) using the CuKα ray. The measurement conditions were as follows: 40-kV voltage; 100-mA current; 4-degree/minute scanning rate; 0.02-degree sampling frequency; one-time cumulated number; and the measurement range (2θ) of from 10 to 60 degrees by diffraction angle.

In addition, according to a thermogravimetric analysis, a “SPAN” exhibited a weight reduction of 10% or less when it was 400° C. upon being heated from room temperature up to 900° C. at a temperature increment rate of 20° C./minute. In contrast to the “SPAN,” when the mixed raw material of a sulfur powder and a “PAN” powder was heated under the same conditions, it was appreciated that the mixed raw material exhibited a weight decrement at around 120° C., and that it suddenly exhibited a greater weight reduction, which resulted from the disappearance of sulfur, when the temperature becomes 200° C. or more.

That is, it is believed that sulfur within a “SPAN” exists in such a stable state that it has bonded to a “PAN.” Alternatively, it is believed that, although the sulfur might possibly keep existing as an elementary substance, the sulfur is put in another state in which it is less likely to vaporize even when being heated, because the sulfur is confined or enclosed within cross-linked structures that occur when the heated “PAN” undergoes ring-closing reactions.

FIG. 2 illustrates an example of a Raman spectrum that a “SPAN” exhibited. In the Raman spectrum shown in FIG. 2, a major peak of the Raman shifts exists at around 1,331 cm⁻¹, and other peaks of the Raman shifts exist at around 1,548 cm⁻¹, 939 cm⁻¹, 479 cm⁻¹, 381 cm⁻¹ and 317 cm⁻¹, in a range of from 200 cm⁻¹ to 1,800 cm⁻¹. These peaks of the Raman shifts being specified herein can be observed at the same positions even when a ratio of a sulfur elementary substance to a “PAN” is changed in the resulting “SPAN.” Consequently, the peaks characterize a “SPAN,” namely, the negative-electrode active material according to the present invention. Moreover, each of the peaks exists within a range of roughly ±8 cm⁻¹ about each of the peak positions serving as the center. In addition, note that, in the present specification, the term, “major peak,” designates a peak whose peak height is the maximum in all the peaks that have appeared in a Raman spectrum.

For reference, the above-described Raman shifts were measured by “RMP-320,” a product of JASCO Corporation, whose excitation wavelength λ was 532 nm, grating was 1,800 grooves per millimeter, and resolution was 3 cm⁻¹. Note that, in Raman spectra, the number of peaks may change, or the position of peak top may deviate, depending on the differences between the wavelengths of incident light or between the resolutions. Therefore, when the Raman spectrum of a negative electrode comprising a “SPAN” is analyzed, it is possible to ascertain the same peaks as those described above, or it is possible to ascertain peaks that are different slightly from the above-described peaks in terms of the number of peaks, or in terms of the position of peak top.

(Negative Electrode for Secondary Battery)

A negative electrode for secondary battery according to the present invention comprises the above-described present negative-electrode active material including a “SPAN.” The present negative electrode can be constructed in the same manner as common negative electrodes for secondary battery. For example, the present negative electrode can be manufactured by applying a negative-electrode material, which comprises the present negative-electrode active material including a “SPAN,” onto a current collector. In addition to the present negative-electrode active material, the negative-electrode material can further comprise, if needed, at least one member being selected from the group consisting of conductive additives, binders (or fastening agents), and solvents, all of which are to be mixed with the present negative-electrode active material.

For example, it is feasible that a “SPAN” being obtainable by the above-described process can further comprise a conductive additive and/or a binder. A conductive additive to be further included in the “SPAN” can be the following: acetylene black (or AB), KETJENBLACK (or KB), and gas-phase-method carbon fibers (or vapor grown carbon fibers (or VGCF)).

Moreover, the binder to be further included in the “SPAN” can be the following: polyvinylidene fluoride (e.g., polyvinylidene difluoride (or PVDF)), polytetrafluoroethylene (or PTFE), styrene-butadiene rubber (or SBR), polyimide (or PI), polyamide-imide (or PAI), carboxymethyl cellulose (or CMC), ployvinyl chloride (or PVC), methacryl resins (or PMA), polyacrylonitrile (or PAN), modified polyphenylene oxide (or PPO), polyethylene oxide (or PEO), polyethylene (or PE), and polypropylene (or PP).

In addition, the solvent to be used with the “SPAN” can be the following: N-methyl-2-pyrrolidone, N, N-dimethylformamide, alcohols, and water. Note that the “SPAN” can be mixed with a plurality of members of the respective conductive additives, binders and solvents to use. Compounding amounts of the conductive additives, binders and solvents do not matter at all especially. However, it is preferable to compound a conductive additive in an amount of from 20 to 100 parts by mass approximately, and a binder in an amount of from 10 to 20 parts by mass approximately, for instance, with respect to 100 parts by mass of the resulting negative-electrode active material according to the present invention. Moreover, as another method for manufacturing the negative electrode for secondary battery according to the present invention, it is possible to press attach a mixture of the present negative-electrode active material, one of the conductive additives given above and one of the binders given above onto one of the surfaces of a current collector by a pressing machine after applying the mixture onto and then drying it on the one of the surfaces.

A current collector to be employed can be those which have been used commonly in electrodes for secondary battery. For example, it is possible to exemplify the following for the current collector to be used: aluminum foils, aluminum meshes, punched aluminum sheets, aluminum expanded sheets, stainless-steel foils, stainless-steel meshes, punched stainless-steel sheets, stainless-steel expanded sheets, foamed nickel, nickel nonwoven fabrics, copper foils, copper meshes, punched copper sheets, copper expanded sheets, titanium foils, titanium meshes, and carbon papers (e.g., carbon nonwoven fabrics/woven fabrics). Among them, a carbon-paper current collector comprising carbon whose graphitization degree is high is suitable for the current collector to be used for the negative-electrode active material according the present invention, because it neither includes any hydrogen nor exhibits any high reactivity to sulfur. A raw material to be used for carbon fibers with high graphitization degree can be various types of pitches making a material for carbon fibers, and polyacrylonitrile fibers. Note that the pitches can be the byproducts of petroleum, coal and coal tar, for instance.

Note herein that the negative electrode according to the present invention can preferably comprise a current collector being made of aluminum, and the negative-electrode active material according to the present invention that covers the current collector, for instance. Since the “SPAN” in the present negative-electrode active material is less likely to alloy with aluminum, the dendrite of lithium is less likely to occur so that the fear of short-circuiting hardly arises. The present negative electrode not only makes it possible to keep down material and manufacturing costs of the resulting secondary batteries, but also makes it possible to make the resultant secondary batteries lightweight. Moreover, using a current collector being made of aluminum for a positive electrode, namely, the counter electrode, enables battery manufactures to form a negative-electrode active-material layer and a positive-electrode active-material layer on the front and back faces of the current collector, respectively, when they assemble a bipolar battery. Thus, using a current collector being made of aluminum for the negative and positive electrodes makes it possible to simplify the construction of bipolar battery.

### Secondary Battery

A secondary battery according to the present invention comprises the above-described negative electrode according to the present invention, a positive electrode, and an electrolyte. It is possible to apply the present secondary battery to lithium-ion secondary batteries, sodium-ion secondary batteries, and the other secondary batteries.

A positive electrode to be used in the secondary battery according to the present invention can preferably comprise a positive-electrode active material that is capable of sorbing (or occluding) and desorbing (or releasing) lithium ions or sodium ions. The positive electrode can preferably comprise a current collector, and a positive-electrode active-material layer including a positive-electrode active material and covering a surface of the current collector. The positive-electrode active material can preferably make a positive-electrode material along with a binding agent and/or a conductive additive. Although the binding agent and conductive additive for the positive electrode are not limited especially at all, they can be made up of the same binding agents and conductive additives as those that have been used for negative-electrode materials, for instance.

A usable positive-electrode active material that is capable of sorbing and desorbing lithium ions can be one of metallic composite oxides of lithium and transition metals, such as lithium-manganese-based composite oxides, lithium-cobalt-based composite oxides and lithium-nickel-based composite oxides, for instance. The lithium-manganese-based composite oxides can preferably comprise at least one member being selected from the group consisting of LiNi_{1/3}Co_{1/3}Mn_{1/3}O₂, LiMn₂O₄, LiNi_{0.5}Mn_{1.5}O₄ and Li₂MnO₃—Li“M”O₂ (where “M” stands for at least one member being selected from the group consisting of Ni, Co and Mn), for instance. The lithium-cobalt-based composite oxides can preferably comprise LiCoO₂, for instance. The lithium-nickel-based composite oxides can preferably comprise at least one member being selected from the group consisting of LiNiO₂, LiNi_{1/3}Co_{1/3}Mn_{1/3}O₂, LiNi_{0.5}Mn_{1.5}O₄ and Li₂MnO₃—Li“M”O₂ (where “M” stands for at least one member being selected from the group consisting of Ni, Co and Mn), for instance.

A usable positive-electrode active material that is capable of sorbing and desorbing sodium ions can be one of substances in which sodium substitutes for lithium in active materials for lithium-ion batteries. For example, the usable substances can be metallic composite oxides of sodium and transition metals, such as Na“M”O₂ (where “M” stands for at least one member being selected from the group consisting of Co, Ni and Mn) and Na“M”PO₄ (where “M” stands for at least one member being selected from the group consisting of Fe, Mn, Co and Ni).

A current collector being usable for the positive electrode of the secondary battery according to the present invention can be those which have been employed commonly for positive electrodes for lithium-ion secondary batteries, such as aluminum, nickel and stainless steels. Moreover, the current collector can have various sorts of configurations, such as meshes and foils.

When the secondary battery according to the present invention makes a lithium-ion secondary battery, a usable electrolyte can be at least one of the following: LiPF₆, LiBF₄, LiAsF₆, LiCF₃SO₃, LiI, and LiClO₄. Meanwhile, when the present secondary battery makes a sodium-ion secondary battery, a usable electrolyte can be at least one member, or a plurality of members, being selected from the group consisting of NaPF₆, NaBF₄, NaClO₄, NaAsF₆, NaSbF₆, NaCF₃SO₃, NaN(SO₂CF₃)₂, sodium salts of lower fatty acids, and NaAlCl₄.

Even among those various electrolytes given above, the following can be used preferably because they comprise fluorine (F): LiPF₆, LiBF₄, LiAsF₆, LiCF₃SO₃, NaPF₆, NaBF₄, NaAsF₆ᵣ NaSbF₆, NaCF₃SOF₃, and NaN(SO₂CF₃)₂. In an electrolytic solution containing one of the electrolytes, the electrolyte can have a concentration falling in a rage of from 0.5 to 1.7 mol/L approximately.

For example, one of the electrolytes can preferably make a nonaqueous electrolytic solution. A nonaqueous electrolytic solution comprises a nonaqueous solvent, and an electrolyte being dissolved in the nonaqueous solvent. The nonaqueous solvent can be made of organic solvents. A usable organic solvent can preferably be at least one member being selected from the group consisting of ethylene carbonate, propylene carbonate, dimethyl carbonate, diethyl carbonate, ethyl methyl carbonate, dimethyl ether, isopropyl methyl carbonate, vinylene carbonate, γ-butyrolactone, and acetonitrile. Note that the electrolytes are not at all limited to being in the form of liquid, but can even be in the form of solid, for example, in the form of polymeric gel.

The secondary battery according to the present invention can further comprise extra members as well, such as a separator, in addition to the above-described negative electrode, positive electrode and nonaqueous electrolytic solution. A separator intervenes between the positive electrode and the negative electrode. Thus, the separator not only allows the migrations of ions between the positive electrode and the negative electrode, but also prevents the positive electrode and the negative electrode from internally short-circuiting one another. When the present secondary battery makes a hermetically-closed battery, it is necessary for the separator to have a function of retaining the electrolytic solution therein, too. A usable separator can preferably be thin-thickness and microporous or nonwoven-fabric-shaped films. The thin-thickness and microporous or nonwoven-fabric-shaped films can preferably be made from at least one member being selected from the group consisting of polyethylene, polypropylene, polyacrylonitrile, aramide, polyimide, cellulose, and glass. Although a configuration of the present secondary battery is not limited especially at all, the present secondary battery can have a variety of configurations, such as cylindrical shapes, laminated shapes, and coin shapes.

For example, vehicles, such as electric vehicles and hybrid vehicles, can have the secondary battery according to the present invention on-board. In addition to the vehicles, various battery-driven home electric appliances (e.g., personal computers and portable communication gadgets), office devices and industrial instruments can also have the present secondary battery on-board as well.

### EXAMPLES

### Example No. 1

A secondary battery according to Example No. 1 of the present invention made a lithium-ion secondary battery that comprised a negative electrode including a “SPAN,” and a positive electrode including LiNi_{0.5}Mn_{1.5}O₄.

### Production of “SPAN”

A sulfur powder, and a polyacrylonitrile (i.e., “PAN”) powder were prepared. The sulfur powder was classified to make the particle diameters 50 μm or less using a sieve. Meanwhile, the “PAN” powder had particle diameters falling in a range of from 0.2 to 2 μm when being ascertained by an electron microscope. A mixed raw material was made by mixing 5 parts by mass of the sulfur powder and 1 part by mass of the “PAN” powder one another and then pulverizing them with a mortar and pestle.

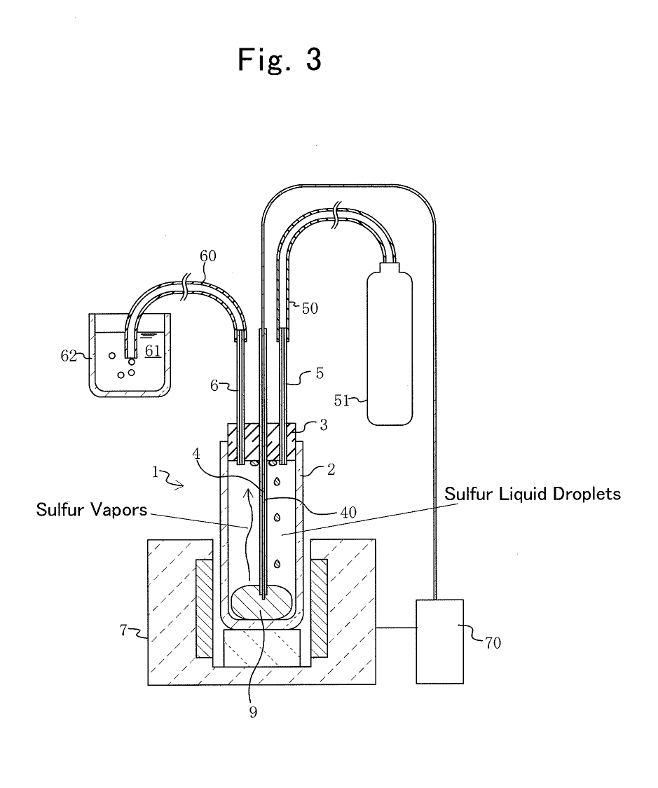

A heat-treatment step for the resulting mixed raw material will be hereinafter described. In the heat-treatment step, a reaction apparatus 1 as shown in FIG. 3 was used to heat treat a mixed raw material 9. As illustrated in the drawing, the reaction apparatus 1 comprised a reaction container 2, a lid 3, a thermocouple 4, an alumina protective tube 40, two alumina tubes (i.e., a gas introduction tube 5, and a gas discharge tube 6), an argon-gas pipe 50, a gas tank 51, a trap pipe 60, a trapping bath 62, an electric furnace 7, and a temperature controller 70. Note that the gas tank 51 held an argon gas therein, the trapping bath 62 held a sodium hydroxide aqueous solution 61 therein, and the temperature controller 70 was connected with the electric furnace 7.

The used reaction container 2 was a glass tube being made of quartz glass that was formed as a bottomed cylindrical shape. The mixed raw material 9 was accommodated in the reaction container 2. The reaction container 2 was closed at the opening with the lid 3 being made of glass that had three through holes. The alumina protective tube 40 (e.g., “Alumina SSA-S,” a product of NIKKATO Co., Ltd.) holding the thermocouple 4 therein was fitted into one of the three through holes. The gas introduction tube 5 (e.g., “Alumina SSA-S,” a product of NIKKATO Co., Ltd.) was fitted into the other one of the through holes. The gas discharge tube 6 (e.g., “Alumina SSA-S,” a product of NIKKATO Co., Ltd.) was fitted into the other remaining one of the through holes. Note that the reaction container 2 had 60 mm in outside diameter, 50 mm in inside diameter, and 300 mm in length. The alumina protective tube 40 had 4 mm in outside diameter, 2 mm in inside diameter, and 250 mm in length. The gas introduction tube 5 and gas discharge tube 6 had 6 mm in outside diameter, 4 mm in inside diameter, and 150 mm in length, respectively. The gas introduction tube 5 and gas discharge tube 6 were exposed on the inner face of the lid 3 (namely, they protruded into the reaction container 2) at the leading end, respectively. The exposed leading ends had a length of 3 mm. The leading ends of the gas introduction tube 5 and gas discharge tube 6 became nearly 100° C. or less in the heat-treatment step. Hence, sulfur vapors occurring in the heat-treatment step did not flow out through the gas introduction tube 5 and gas discharge tube 6, but were returned back (or refluxed) to the reaction container 2.

The thermocouple 4, which was fit into the alumina protective tube 40, measured indirectly at the leading end temperatures of the mixed raw material 9 inside the reaction container 2. The thermocouple 4 fed back the measured temperatures to the temperature controller 70 for the electric furnace 7.

The gas introduction tube 5 was connected with the argon-gas pipe 50. The argon-gas pipe 50 was connected with the gas tank 51 holding an argon gas therein. The trap pipe 60 was connected with the gas discharge tube 6 at one of the opposite ends. The trap pipe 60 was further inserted at the other one of the opposite ends into the sodium hydroxide aqueous solution 61 inside the trapping bath 62. Note that the trap pipe 60 and trapping bath 62 trapped hydrogen sulfide gases occurring in the heat-treatment step.

The reaction container 2 holding the mixed raw material 9 therein was accommodated in the electric furnace 7. Note that the electric furnace 7 comprised a crucible furnace whose opening width was φ80 mm and heating height was 100 mm. Then, an argon gas was introduced into the interior of the reaction container 2 by way of the gas introduction tube 5. A flow rate of the argon gas on this occasion was 100 mL/min. After 10 minutes passed since the introduction of argon gas had started, the mixed raw material 9 inside the reaction container 2 was started being heated while keeping introducing the argon gas. A temperature increment rate on this occasion was 5° C./min. When the mixed raw material 9 became 100° C., the argon gas was stopped being introduced while keeping heating the mixed raw material 9. When the mixed raw material 9 became about 200° C., gases generated. The mixed raw material 9 was stopped being heated after it became 360° C. After the heating is stopped, the temperature of the mixed raw material 9 rose up to 400° C., and then declined thereafter. Therefore, in the heat-treatment step, the mixed raw material 9 was heated up to 400° C. Thereafter, the mixed raw material 9 was cooled naturally, and a product (that is, a post-heat-treatment-step processed body) was taken out from the reaction container 2 when the mixed raw material 9 was cooled down to room temperature (i.e., about 25° C.). Note that sulfur was refluxed because the heating time on this occasion was for about 10 minutes at 400° C.

Then, a sulfur-elementary-substance removal step being described hereinafter was carried out in order to remove sulfur elementary substances (or free sulfur) remaining in the post-heat-treatment-step processed body. The post-heat-treatment-step processed body was pulverized with a mortar and pestle. The pulverized substance was put in a glass tube in an amount of 2 grams, and was then heated at 200° C. for 3 hours while subjecting it to vacuum suctioning. A temperature increment rate on this occasion was 10° C./min. The sulfur-elementary-substance removal step enabled sulfur elementary substances, which were remaining in the post-heat-treatment-step processed body, to be evaporated and then removed. Thus, a “SPAN” was produced which were free from sulfur elementary substances, or which hardly included any sulfur elementary substances.

According to an elementary analysis that was carried out for the resulting “SPAN,” it was ascertained that sulfur, carbon, and so on, existed. Moreover, according to a Raman spectroscopic analysis that was carried out for the resultant “SPAN” to analyze the Raman spectrum, it was appreciated that the “SPAN” exhibited Raman-shift peaks, which are specific to “SPAN,” at around 1,331 cm⁻¹, and so forth, in the resulting Raman spectrum.

### Manufacture of Lithium-Ion Secondary Battery

### (1) Negative Electrode Including “SPAN”

A mixture was made by mixing the following one another: the “SPAN” being produced as described above; KETJENBLACK (or KB) serving as a conductive additive; and polyvinylidene fluoride (e.g., PVdF) serving as a binder. In the resulting mixture, a mixed ratio of the components was set to be “SPAN”:KB:PVdF=75:5:20 by mass. Then, a slurry was prepared by adding a viscosity adjuster solvent (e.g., N-methyl-2-pyrolidone (or NMP)) to the mixture. The resultant slurry was applied onto a current collector being made of aluminum foil, and was dried preliminarily at 80° C. for 20 minutes in air. Moreover, the slurry was further dried at 150° C. for 3 hours under reduced pressure. Thus, a negative electrode including the “SPAN” (hereinafter being referred to as a “‘SPAN’ negative electrode”) was fabricated. The resulting “SPAN” negative electrode was punched out to an electrode element with a size of 11 mm in diameter, and was thereby made applicable to a secondary battery according to Example No. 1 of the present invention. Note that the “SPAN” negative electrode exhibited a capacity of 2.52 mAh that was convertible to 600 mAh/g.

### (2) Lithium Pre-Doping

The “SPAN” negative electrode, and metallic lithium were used to fabricate a half-cell. Moreover, a glass filter (e.g., “GA100,” a product of ADVANTEC Co., Ltd.) was used for the half-cell's separator. In addition, a nonaqueous electrolytic solution was used for the half-cell's electrolytic solution. Note that the used nonaqueous solution was prepared by dissolving LiPF₆ in an amount of 1 mol/L in a solvent mixture of ethylene carbonate (or EC) and diethyl carbonate (or DEC). Moreover, in the solvent mixture, a mixed ratio of the components was set to be EC:DEC=1:1 by volume. In addition, a coin-shaped case was used for the half-cell's case.

With use of the resulting half-cell, the “SPAN” negative electrode was subjected to a lithium pre-doping treatment. That is, a constant electric current (e.g., 0.504 mA (being convertible to 120 mAh/g) was flowed at a rate of 0.2 C beginning with an open voltage (e.g., about 3V) in order to cause the “SPAN” negative electrode to sorb lithium ions. Then, when the half-cell reached to produce 1 V, the electric current was stopped flowing temporarily for 5 minutes. Thereafter, the same constant electric current was flowed at a rate of 0.2 C in the opposite direction in order to cause the “SPAN” negative electrode to desorb lithium ions. Note that, taking a capacity of 1.63 mAh, which a later-described positive electrode to be combined with the “SPAN” negative electrode exhibited, into consideration, the electric current was stopped flowing in the opposite direction for good when the “SPAN” negative electrode desorbed lithium ions in such an amount that was equivalent to 1.7 mAh.

### (3) Positive Electrode Including LiNi_{0.5}Mn_{1.5}O₄

A mixture was made by mixing the following one another: LiNi_{0.5}Mn_{1.5}O₄ serving as a positive-electrode active material; KETJENBLACK (or KB) serving as a conductive additive; and polyvinylidene fluoride (e.g., PVdF) serving as a binder. In the resulting mixture, a mixed ratio of the components was set to be LiNi_{0.5}Mn_{1.5}O₄:KB:PVdF=90:5:5 by mass. Then, a slurry was prepared by adding a viscosity adjuster solvent (e.g., N-methyl-2-pyrolidone (or NMP)) to the mixture. The resultant slurry was applied onto a current collector being made of aluminum foil, and was dried preliminarily at 80° C. for 20 minutes in air. Moreover, the slurry was further dried at 150° C. for 3 hours under reduced pressure. Thus, a positive electrode including LiNi_{0.5}Mn_{1.5}O₄ (hereinafter being referred to as an “LiNi_{0.5}Mn_{1.5}O₄ positive electrode”) was fabricated. The resulting LiNi_{0.5}Mn_{1.5}O₄ positive electrode was punched out to an electrode element with a size of 11 mm in diameter, and was thereby made applicable to a secondary battery according to Example No. 1 of the present invention. Note that the LiNi_{0.5}Mn_{1.5}O₄ positive electrode exhibited a capacity of 1.63 mAh that was convertible to 140 mAh/g.

### (4) Secondary Battery

The above-described half-cell was disassembled to take out the “SPAN” negative electrode that had been subjected to the lithium pre-doping treatment. The taken-out “SPAN” negative electrode, and the above-described LiNi_{0.5}Mn_{1.5}O₄ positive electrode were used to build a coin-shaped secondary battery in the same manner as the half-cell was built as described above. The resulting secondary battery was labeled a secondary battery according to Example No. 1 of the present invention.

### (5) Evaluations on Charging and Discharging Characteristics

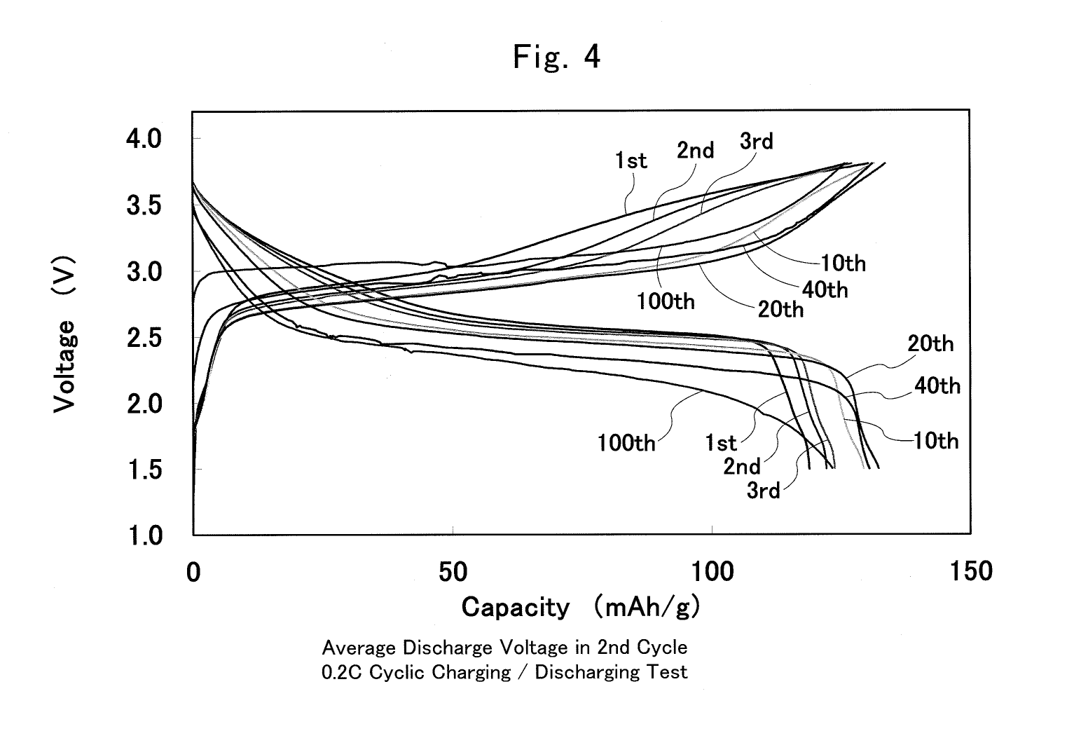

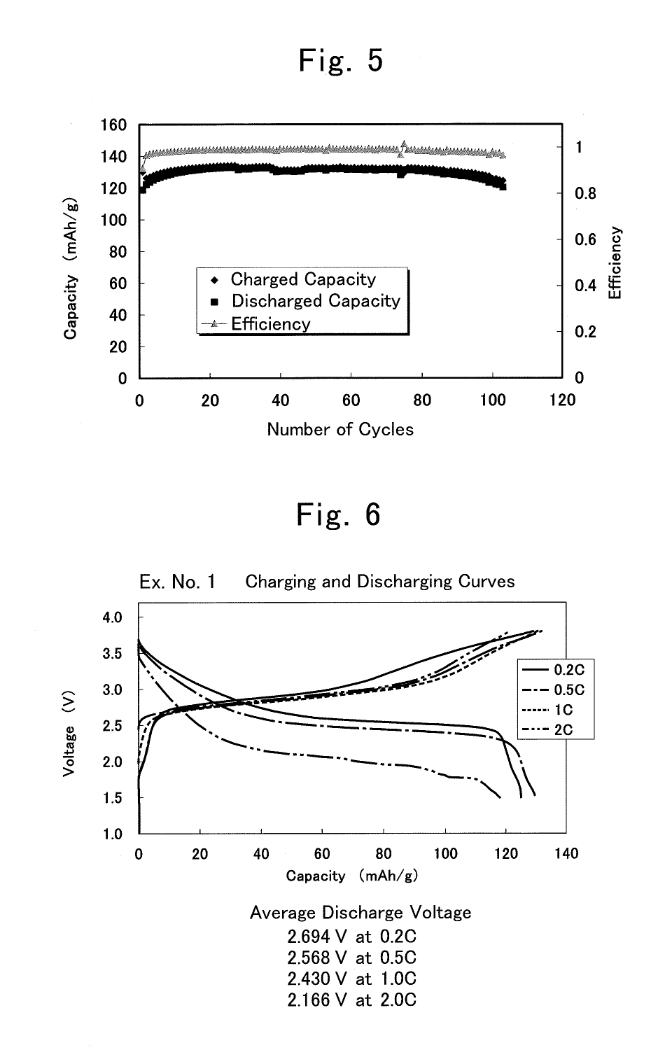

The thus manufactured secondary battery according to Example No. 1 of the present invention was charged and discharged repeatedly between an upper-limit voltage (e.g., 3.8 V) and a lower-limit voltage (e.g., 1.5 V). Note that an electric current was flowed at a rate of 0.2 C (i.e., equivalent to 0.326 mA, which was convertible to 28 mA/g, for the case of the present secondary battery according to Example No. 1). Moreover, a temperature was set at 30° C. during the cyclic charging/discharging test. FIGS. 4 and 5 illustrate results of the cyclic charging/discharging test. The horizontal axis in FIG. 4 specifies capacities, and the vertical axis in the drawing specifies voltages. In FIG. 4, the curves increasing rightward show charging curves in the respective cycles, whereas the curves decreasing rightward show discharging curves in the respective cycles. The horizontal axis in FIG. 5 specifies the number of cycles, the left vertical axis in the drawing specifies capacities, and the right vertical axis in the drawing specifies coulomb efficiencies (being abbreviated to as “Efficiency” in the drawing). Note that a coulomb efficiency is a rate of a discharged capacity exhibited by a battery to a charged capacity exhibited by the battery and being taken as 1 in each of the charging and discharging cycles.

As illustrated in FIGS. 4 and 5, the secondary battery according to Example No. 1 of the present invention produced an average discharge voltage of about 2.7 V in the voltage range of from 3.8 to 1.5 V. Moreover, the present secondary battery according to Example No. 1 exhibited an initial discharged capacity of 122 mAh/g approximately. That is, it was feasible for the present secondary battery according to Example No. 1 to have a high negative-electrode capacity being about four times as much as that was exhibited by a secondary battery in which Li₄Ti₅O₁₂ was used as the negative-electrode active material. Note that Li₄Ti₅O₁₂ has been said to produce a high discharge voltage, and to be of high safety.

It was understood from the above-described results that a secondary battery according to the present invention, which comprises LiNi_{0.5}Mn_{1.5}O₄ serving as a positive-electrode active material and a “SPAN” serving as a negative-electrode active material, can not only produce a higher discharge voltage but also exhibit an enhanced energy density per its unit mass or volume.

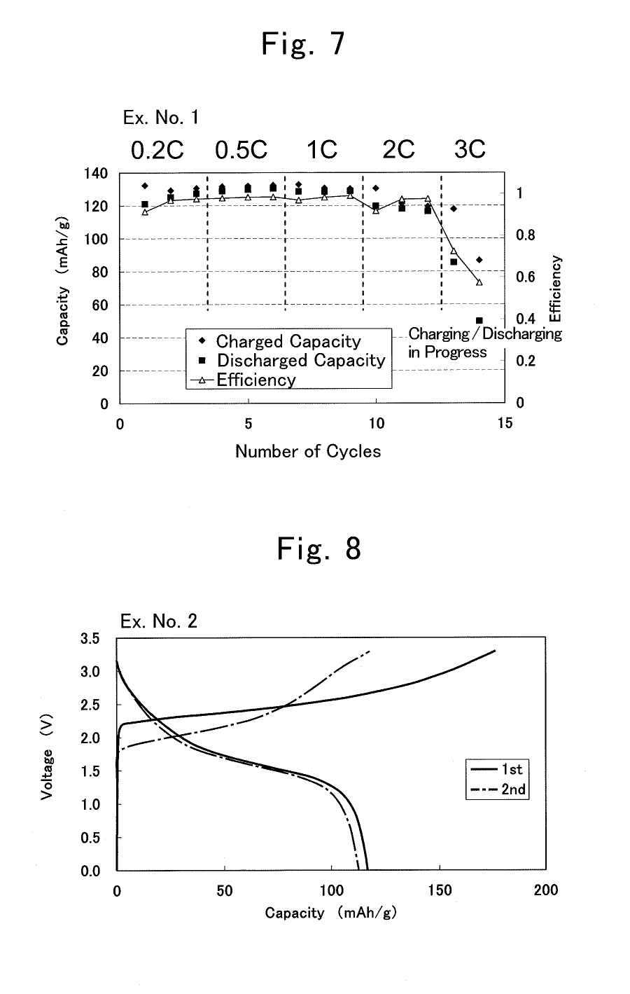

Moreover, the secondary battery according to Example No. 1 of the present invention was also evaluated for the rate characteristic as well. That is, the present secondary battery according to Example No. 1 was subjected to a cyclic rate-characteristic test in which the discharge rate was changed from that of the initial cycle for every three cycles in the following order: 0.2 C, 0.5 C, 1 C, 2 C and 3 C. Note however that the charge rate was fixed at a rate of 0.2 C. Moreover, a temperature was set at 30° C. during the cyclic rate-characteristic test. FIGS. 6 and 7 illustrate result of the cyclic rate-characteristic test. As shown in FIG. 6, the present secondary battery according to Example No. 1 exhibited an average discharge voltage of about 2.7 V, about 2.6 V, about 2.4 V, and about 2.2 V, respectively, at 0.2 C, 0.5 C, 1.0 C, and 2.0 C. Thus, it was possible for the present secondary battery according to Example No. 1 to produce higher discharge voltages in a range where the discharge rate was changed from 0.2 C and up to 2 C.

As shown in FIG. 7, the secondary battery according to Example No. 1 of the present invention exhibited proportions of the discharged capacities to the charged capacities, which approximated 100%, in a range where the discharge rate was changed from 0.2 C to 1 C. Moreover, even when the discharge rate was 2 C, the present secondary battery according to Example No. 1 exhibited high proportions of the discharged capacities to the charged capacities that were 90% or more. It was understood from these results that a secondary battery according to the present invention, which comprises LiNi_{0.5}Mn_{1.5}O₄ serving as a positive-electrode active material and a “SPAN” serving as a negative-electrode active material, can demonstrate a higher rate characteristic.

### Example No. 2

A secondary battery according to Example No. 2 of the present invention was a lithium-ion secondary battery comprising a negative electrode, which included a “SPAN,” and a positive electrode, which included LiNi_{1/3}Co_{1/3}Mn_{1/3}O₂.

### (1) Negative Electrode Including “SPAN”

A mixture was made by mixing the following one another: the “SPAN” being produced as described above; KETJENBLACK (or KB) serving as a conductive additive; and polyvinylidene fluoride (e.g., PVdF) serving as a binder. In the resulting mixture, a mixed ratio of the components was set to be “SPAN”:KB:PVdF=75:5:20 by mass. Then, a slurry was prepared by adding a viscosity adjuster solvent (e.g., N-methyl-2-pyrolidone (or NMP)) to the mixture. The resultant slurry was applied onto a current collector being made of aluminum foil, and was dried preliminarily at 80° C. for 20 minutes in air. Moreover, the slurry was further dried at 150° C. for 3 hours under reduced pressure. Thus, a “SPAN” negative electrode was fabricated. The resulting “SPAN” negative electrode was punched out to an electrode element with a size of 11 mm in diameter, and was thereby made applicable to a secondary battery according to Example No. 2 of the present invention. Note that the resultant “SPAN” negative electrode exhibited a capacity of 1.70 mAh that was convertible to 600 mAh/g. Moreover, the resulting green “SPAN” negative electrode according to Example No. 2 had not been subjected to any lithium pre-doping treatment.

### (2) Positive Electrode Including LiNi_{1/3}Co_{1/3}Mn_{1/3}O₂

A mixture was made by mixing the following one another: LiNi_{1/3}Co_{1/3}Mn_{1/3}O₂ serving as a positive-electrode active material; KETJENBLACK (or KB) serving as a conductive additive; and polyvinylidene fluoride (e.g., PVdF) serving as a binder. In the resulting mixture, a mixed ratio of the components was set to be LiNi_{1/3}Co_{1/3}Mn_{1/3}O₂:KB:PVdF=90:5:5 by mass. Then, a slurry was prepared by adding a viscosity adjuster solvent (e.g., N-methyl-2-pyrolidone (or NMP)) to the mixture. The resultant slurry was applied onto a current collector being made of aluminum foil, and was dried preliminarily at 80° C. for 20 minutes in air. Moreover, the slurry was further dried at 150° C. for 3 hours under reduced pressure. Thus, a positive electrode including LiNi_{1/3}Co_{1/3}Mn_{1/3}O₂ (hereinafter being referred to as an “LiNi_{1/3}Co_{1/3}Mn_{1/3}O₂ positive electrode”) was fabricated. The resulting LiNi_{1/3}Co_{1/3}Mn_{1/3}O₂ positive electrode was punched out to an electrode element with a size of 11 mm in diameter, and was thereby made applicable to a secondary battery according to Example No. 2 of the present invention. Note that the resultant LiNi_{1/3}Co_{1/3}Mn_{1/3}O₂ positive electrode exhibited a capacity of 2.25 mAh that was convertible to 170 mAh/g.

### (3) Secondary Battery

With use of the above-described “SPAN” negative electrode and LiNi_{1/3}Co_{1/3}Mn_{1/3}O₂ positive electrode, a lithium-ion secondary battery according to Example No. 2 of the present invention was manufactured. Note that all of the other constituent elements being used, such as an electrolytic solution, separator and battery case, were the same as those constituent elements of the present secondary battery according to Example No. 1.

### (4) Evaluation on Charging and Discharging Characteristics

The thus manufactured secondary battery according to Example No. 2 of the present invention was charged and discharged repeatedly between an upper-limit voltage (e.g., 3.8 V) and a lower-limit voltage (e.g., 0.0 V). Note that an electric current was flowed at a rate of 0.2 C (i.e., equivalent to 0.45 mA, which was convertible to 34 mA/g, for the case of the present secondary battery according to Example No. 2). Moreover, a temperature was set at 30° C. during the cyclic charging/discharging test. FIG. 8 illustrates results of the cyclic charging/discharging test. That is, the drawing illustrates charging and discharging curves that the present secondary battery according to Example No. 2 exhibited.

As shown in FIG. 8, the present secondary battery according to Example No. 2 had such a large difference as about 50 mAh/g approximately between the first-round charged capacity and the first-round discharged capacity. The large difference resulted from the fact that the “SPAN” negative electrode was doped with lithium that was supplied from the LiNi_{1/3}Co_{1/3}Mn_{1/3}O₂ positive electrode. Since the “SPAN” negative electrode had been pre-doped with lithium in the first round of charging and discharging cycles, the present secondary battery according to Example No. 2 exhibited capacities that were stabilized substantially after the subsequent second round of charging and discharging cycles or later. For example, the present secondary battery according to Example No. 2 not only exhibited a discharged capacity of 112 mAh/g in the second round of charging and discharging cycles, but also produced an average discharge voltage of 1.7 V.

As having been described so far, it was also possible for the present lithium-ion secondary battery according to Example No. 2 comprising the above-described “SPAN” negative electrode and LiNi_{1/3}Co_{1/3}Mn_{1/3}O₂ positive electrode as well to exhibit higher capacities.

Moreover, the LiNi_{1/3}Co_{1/3}Mn_{1/3}O₂ positive electrode had a wide temperature range where it was employable. That is, it was feasible for the present lithium-ion secondary battery according to Example No. 2, which was manufactured by assembling the LiNi_{1/3}Co_{1/3}Mn_{1/3}O₂ positive electrode along with the “SPAN” negative electrode, to operate in such a wider temperature as from −30 to 80° C., for instance.

### Example No. 3

A secondary battery according to Example No. 3 of the present invention was a lithium-ion secondary battery comprising a negative electrode, which included a “SPAN,” and a positive electrode, which included LiNiMn₂O₄.

### (1) Negative Electrode Including “SPAN”

A mixture was made by mixing the following one another: the “SPAN” being produced as described above; KETJENBLACK (or KB) serving as a conductive additive; and polyvinylidene fluoride (e.g., PVdF) serving as a binder. In the resulting mixture, a mixed ratio of the components was set to be “SPAN”:KB:PVdF=75:5:20 by mass. Then, a slurry was prepared by adding a viscosity adjuster solvent (e.g., N-methyl-2-pyrolidone (or NMP)) to the mixture. The resultant slurry was applied onto a current collector being made of aluminum foil, and was dried preliminarily at 80° C. for 20 minutes in air. Moreover, the slurry was further dried at 150° C. for 3 hours under reduced pressure. Thus, a “SPAN” negative electrode was fabricated. The resulting “SPAN” negative electrode was punched out to an electrode element with a size of 11 mm in diameter, and was thereby made applicable to a secondary battery according to Example No. 3 of the present invention. Note that the resultant “SPAN” negative electrode exhibited a capacity of 2.03 mAh that was convertible to 600 mAh/g. Moreover, the resulting green “SPAN” negative electrode according to Example No. 3 had not been subjected to any lithium pre-doping treatment.

### (2) Positive Electrode Including LiMn₂O₄

A mixture was made by mixing the following one another: LiMn₂O₄ serving as a positive-electrode active material; KETJENBLACK (or KB) serving as a conductive additive; and polyvinylidene fluoride (e.g., PVdF) serving as a binder. In the resulting mixture, a mixed ratio of the components was set to be LiMn₂O₄:KB:PVdF=90:5:5 by mass. Then, a slurry was prepared by adding a viscosity adjuster solvent (e.g., N-methyl-2-pyrolidone (or NMP)) to the mixture. The resultant slurry was applied onto a current collector being made of aluminum foil, and was dried preliminarily at 80° C. for 20 minutes in air. Moreover, the slurry was further dried at 150° C. for 3 hours under reduced pressure. Thus, a positive electrode including LiMn₂O₄ (hereinafter being referred to as an “LiMn₂O₄ positive electrode”) was fabricated. The resulting LiMn₂O₄ positive electrode was punched out to an electrode element with a size of 11 mm in diameter, and was thereby made applicable to a secondary battery according to Example No. 3 of the present invention. Note that the resultant LiMn₂O₄ positive electrode exhibited a capacity of 2.38 mAh that was convertible to 110 mAh/g.

### (3) Secondary Battery

With use of the above-described “SPAN” negative electrode and LiMn₂O₄ positive electrode, a lithium-ion secondary battery according to Example No. 3 of the present invention was manufactured. Note that all of the other constituent elements being used, such as an electrolytic solution, separator and battery case were the same as those constituent elements of the present secondary battery according to Example No. 1.

### (4) Evaluation on Charging and Discharging Characteristics

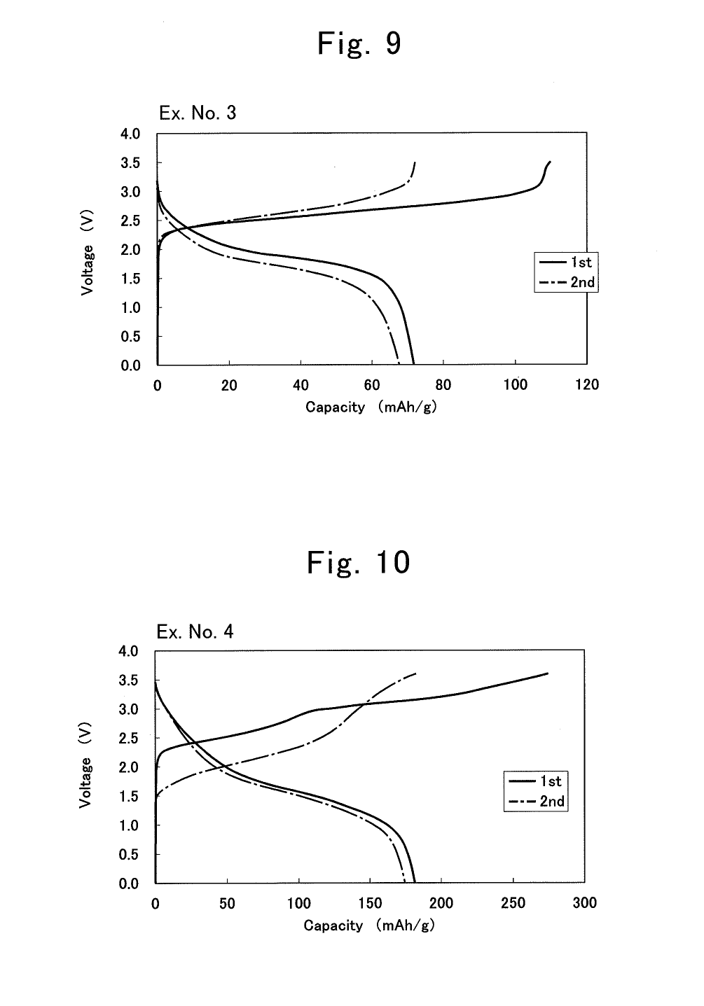

The thus manufactured secondary battery according to Example No. 3 of the present invention was charged and discharged repeatedly between an upper-limit voltage (e.g., 3.5 V) and a lower-limit voltage (e.g., 0.0 V). Note that an electric current was flowed at a rate of 0.2 C (i.e., equivalent to 0.476 mA, which was convertible to 22 mA/g, for the case of the present secondary battery according to Example No. 3). Moreover, a temperature was set at 30° C. during the cyclic charging/discharging test. FIG. 9 illustrates results of the cyclic charging/discharging test. That is, the drawing illustrates charging and discharging curves that the present secondary battery according to Example No. 3 exhibited.

As shown in FIG. 9, the present secondary battery according to Example No. 3 had such a large difference as about 40 mAh/g approximately between the first-round charged capacity and the first-round discharged capacity. The large difference resulted from the fact that the “SPAN” negative electrode was doped with lithium that was supplied from the LiMn₂O₄ positive electrode. Since the “SPAN” negative electrode had been pre-doped with lithium in the first round of charging and discharging cycles, the present secondary battery according to Example No. 3 exhibited capacities that were stabilized substantially after the subsequent second round of charging and discharging cycles or later. For example, the present secondary battery according to Example No. 3 not only exhibited a discharged capacity of 67 mAh/g approximately in the second round of charging and discharging cycles, but also produced an average discharge voltage of 1.69 V.

The above-described results of the cyclic charging/discharging test ascertained that the present lithium-ion secondary battery according to Example No. 3 comprising the above-described “SPAN” negative electrode and LiMn₂O₄ positive electrode could also exhibit higher capacities relatively.

It is possible to keep down a secondary battery comprising the “SPAN” negative electrode and the LiMn₂O₄ positive electrode in terms of the raw-material cost, because LiMn₂O₄, one of the used raw materials, is inexpensive comparatively, and the “SPAN,” another one of the used raw materials, is made from raw materials, such as a sulfur powder and a polyacrylonitrile powder, which are inexpensive relatively.

### Example No. 4

A secondary battery according to Example No. 4 of the present invention was a lithium-ion secondary battery comprising a negative electrode, which included a “SPAN,” and a positive electrode, which included Li₂MnO₃—Li“M”O₂.

### (1) Negative Electrode Including “SPAN”

A mixture was made by mixing the following one another: the “SPAN” being produced as described above; KETJENBLACK (or KB) serving as a conductive additive; and polyvinylidene fluoride (e.g., PVdF) serving as a binder. In the resulting mixture, a mixed ratio of the components was set to be “SPAN”:KB:PVdF=75:5:20 by mass. Then, a slurry was prepared by adding a viscosity adjuster solvent (e.g., N-methyl-2-pyrolidone (or NMP)) to the mixture. The resultant slurry was applied onto a current collector being made of aluminum foil, and was dried preliminarily at 80° C. for 20 minutes in air. Moreover, the slurry was further dried at 150° C. for 3 hours under reduced pressure. Thus, a “SPAN” negative electrode was fabricated. The resulting “SPAN” negative electrode was punched out to an electrode element with a size of 11 mm in diameter, and was thereby made applicable to a secondary battery according to Example No. 4 of the present invention. Note that the resultant “SPAN” negative electrode exhibited a capacity of 1.53 mAh that was convertible to 600 mAh/g. Moreover, the resulting green “SPAN” negative electrode according to Example No. 4 had not been subjected to any lithium pre-doping treatment.

### (2) Positive Electrode Including Li₂MnO₃—Li“M”O₂

Li₂MnO₃—Li“M”O₂ serving as a positive-electrode active material was prepared. Note that the resulting Li₂MnO₃—Li“M”O₂ was a solid solution in which solid Li₂MnO₃ and solid Li“M”O₂ were solved one another. Moreover, “M” in the solid Li“M”O₂ stood for at least one member being selected from the group consisting of Ni, Co and Mn. A mixture was made by mixing the following one another: the Li₂MnO₃—Li“M”O₂; KETJENBLACK (or KB) serving as a conductive additive; and polyvinylidene fluoride (e.g., PVdF) serving as a binder. In the resulting mixture, a mixed ratio of the components was set to be Li₂MnO₃—Li“M”O₂:KB:PVdF=90:5:5 by mass. Then, a slurry was prepared by adding a viscosity adjuster solvent (e.g., N-methyl-2-pyrolidone (or NMP)) to the mixture. The resultant slurry was applied onto a current collector being made of aluminum foil, and was dried preliminarily at 80° C. for 20 minutes in air. Moreover, the slurry was further dried at 150° C. for 3 hours under reduced pressure. Thus, a positive electrode including Li₂MnO₃—Li“M”O₂ (hereinafter being referred to as a “solid solution-based positive electrode”) was fabricated. The resulting solid solution-based positive electrode was punched out to an electrode element with a size of 11 mm in diameter, and was thereby made applicable to a secondary battery according to Example No. 4 of the present invention. Note that the resultant solid solution-based positive electrode exhibited a capacity of 2.19 mAh that was convertible to 270 mAh/g.

### (3) Secondary Battery

With use of the above-described “SPAN” negative electrode and solid solution-based positive electrode, a lithium-ion secondary battery according to Example No. 4 of the present invention was manufactured. Note that all of the other constituent elements being used, such as an electrolytic solution, separator and battery case, were the same as those constituent elements of the present secondary battery according to Example No. 1.

### (4) Evaluation on Charging and Discharging Characteristics

The thus manufactured secondary battery according to Example No. 4 of the present invention was charged and discharged repeatedly between an upper-limit voltage (e.g., 3.8 V) and a lower-limit voltage (e.g., 0.0 V). Note that an electric current was flowed at a rate of 0.2 C (i.e., equivalent to 0.438 mA, which was convertible to 54 mA/g, for the case of the present secondary battery according to Example No. 4). Moreover, a temperature was set at 30° C. during the cyclic charging/discharging test. FIG. 10 illustrates results of the cyclic charging/discharging test. That is, the drawing illustrates charging and discharging curves that the present secondary battery according to Example No. 4 exhibited.

As shown in FIG. 10, the present secondary battery according to Example No. 3 had such a large difference as about 100 mAh/g approximately between the first-round charged capacity and the first-round discharged capacity. The large difference resulted from the fact that the “SPAN” negative electrode was doped with lithium that was supplied from the solid solution-based positive electrode. Since the “SPAN” negative electrode had been pre-doped with lithium in the first round of charging and discharging cycles, the present secondary battery according to Example No. 4 exhibited capacities that were stabilized substantially after the subsequent second round of charging and discharging cycles or later. For example, the present secondary battery according to Example No. 4 not only exhibited a discharged capacity of 175 mAh/g approximately in the second round of charging and discharging cycles, but also produced an average discharge voltage of 1.66 V.

The above-described results of the cyclic charging/discharging test revealed that the initial irreversible capacity of the “SPAN” negative electrode and that of the solid solution-based positive electrode could be canceled with each other to compensate them one another even for the present lithium-ion secondary battery according to Example No. 4 comprising the above-described “SPAN” negative electrode and solid solution-based positive electrode. Moreover, the present lithium-ion secondary battery according to Example No. 4 could exhibit higher capacities.

Table 1 below summarizes features of the above-described secondary batteries according to Example Nos. 1 through 4 of the present invention.

Example Nos. 1 through 4 being described above disclose examples of lithium-ion secondary batteries comprising one of the “SPAN” negative electrodes according to the present invention. The present invention, however, is not limited at all to such a lithium-ion secondary battery. That is, the present “SPAN” negative electrode can be applied to sodium-ion secondary batteries, for instance. When a sodium-ion secondary battery comprises the present “SPAN” negative electrode, the positive electrode can include a positive-electrode active material comprising a substance in which sodium substitutes for lithium in an active material for lithium-ion secondary battery. For example, the substance can beat least one of the following: Na“M”O₂ where “M” stands for at least one member being selected from the group consisting of Co, Ni, and Mn; and Na“M”PO₄ where “M” stands for at least one member being selected from the group consisting of Fe, Mn, Co, and Ni.

### Comparative Example

A lithium-ion secondary battery according to a comparative example was manufactured using the following: a “SPAN” negative electrode that was made by the fabrication process as disclosed above but served as the positive electrode; and SiOₓ (where 0.5≦“x”≦1.5) that served as the negative-electrode active material. The SiOₓ was prepared as follows. Commercially available Si and SiO₂ powders were put into a high-energy planetary ball mill in an equal molar amount to each other, respectively. The Si and SiO₂ powders were milled with the ball mill at a milling rate of 150 G (i.e., 150 times of the gravitational acceleration) in an argon atmosphere for 10 hours. The thus made particulate SiOₓ was used to fabricate a negative electrode in the same manner as disclosed in Example No. 1. Note however that a copper foil was used for a current collector in the resulting negative electrode.

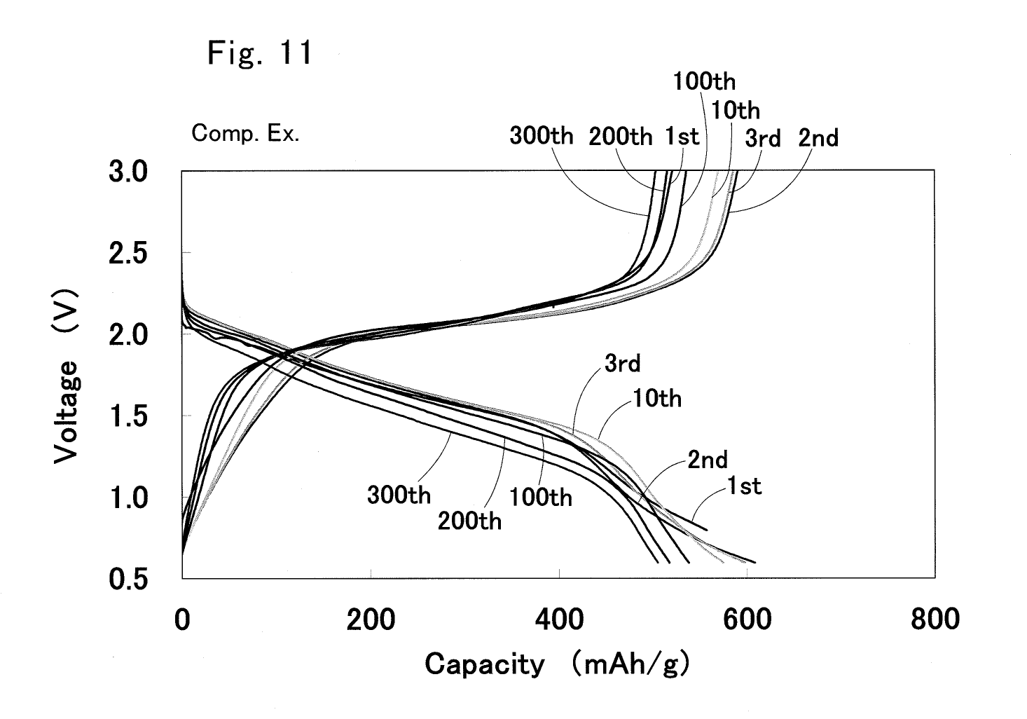

Note that the used positive electrode included the “SPAN” negative electrode that had been fabricated as described in Example No. 1 above. Moreover, the other constituent elements being used, such as an electrolytic solution, separator and battery case, were the same as those constituent elements of the present secondary battery according to Example No. 1. The thus manufactured comparative secondary battery was subjected to a charging/discharging cyclic test under the same conditions as disclosed in Example No. 1. However, the electric current was flowed at a fixed rate of 0.1 C. FIG. 11 illustrates results of the cyclic charging/discharging test. Note that the initial irreversible capacities of the “SPAN” positive electrode and SiOₓ negative electrode had been compensated one another by carrying out a lithium pre-doping treatment in advance with use of a half-cell in the same manner as described in Example No. 1.

As shown in FIG. 11, although the secondary battery according to Comparative Example exhibited a discharge capacity of 610 mAh/g in the second round of charging and discharging cycles, it produced an average discharge voltage of about 1.4 V. On the other hand, the secondary battery according to Example No. 1 of the present invention produced an average discharge voltage of about 2.7 V, as shown in FIG. 4. Therefore, the average discharge voltage produced by the secondary battery according to Comparative Example was lower by a factor of about 0.52 times than the average discharge voltage produced by the present secondary battery according to Example No. 1.

TABLE 1

| | | | | Second-round | |
|---|---|---|---|---|---|
| | | | Average | Discharged | |
| | Positive | Negative | Discharge | Capacity | |
| Identification | Electrode | Electrode | Voltage (V) | (mAh/g) | Feature |
| Example No. 1 | LiNi_{0.5}Mn_{1.5}O₄ | “SPAN” | 2.7 | 122.1 | High-voltage Type |
| Example No. 2 | LiNi_{1/3}Co_{1/3}Mn_{1/3}O₂ | “SPAN” | 1.7 | 112.6 | Operable in Wider |
| | | | | | Temperature Range (e.g., |
| | | | | | from −30 to 80° C.) |
| Example No. 3 | LiMn₂O₄ | “SPAN” | 1.69 | 67.6 | Lower in Cost |
| Example No. 4 | Li₂MnO₃—LiMnO₂ | “SPAN” | 1.66 | 174.6 | Canceled Initial Irreversible |
| | | | | | Capacities of Positive |
| | | | | | and Negative Electrodes |
| Comparative | “SPAN” | SiOₓ | 1.4 | 610.0 | None |
| Example | | | | | |

Having now fully described the present invention, it will be apparent to one of ordinary skill in the art that many changes and modifications can be made thereto without departing from the spirit or scope of the present invention as set forth herein including the appended claims.

What is claimed is:

1. A negative-electrode active material for secondary battery, the negative-electrode active material comprising:
a sulfur-modified polyacrylonitrile including a polyacrylonitrile, and sulfur being introduced into the polyacrylonitrile.

2. The negative-electrode active material according to claim 1, wherein the polyacrylonitrile has an average particle diameter of from 0.5 or more to 50 μm or less.

3. The negative-electrode active material according to claim 1, wherein the polyacrylonitrile exhibits a mass average molecular weight of from 1×10⁴ or more to 3×10⁵ or less.

4. The negative-electrode active material according to claim 1, wherein the sulfur is introduced into the polyacrylonitrile in an amount of from 0.5 or more to 10 or less by mass ratio when an amount of the polyacrylonitrile is taken as 1.

5. The negative-electrode active material according to claim 1, wherein the sulfur-modified polyacrylonitrile exhibits a Raman spectrum having a peak at around 1,331 cm⁻¹ when being subjected to a Raman spectroscopic analysis.

6. A negative electrode for secondary battery, the negative electrode comprising the negative-electrode active material according to claim 1.

7. The negative electrode according to claim 6 further comprising:
a current collector being made of aluminum; and
the negative-electrode active material covering the current collector.

8. A secondary battery comprising:
the negative electrode according to claim 6;
a positive electrode; and
an electrolyte.

9. The secondary battery according to claim 8, wherein the positive electrode includes a positive-electrode active material being capable of sorbing and desorbing lithium ions.

10. The secondary battery according to claim 9, wherein the positive-electrode active material includes a lithium-manganese-based composite oxide.

11. The secondary battery according to claim 10, wherein the lithium-manganese-based composite oxide includes at least one member being selected from the group consisting of LiNi_{1/3}Co_{1/3}Mn_{1/3}O₂, LiMn₂O₄, LiNi_{0.5}Mn_{1.5}O₄, and Li₂MnO₃—Li“M”O₂ (where “M” stands for at least one member being selected from the group consisting of Ni, Co, and Mn).
